(19) United States
(12) Patent Application Publication
(10) Pub. No.: US 2024/0085274 A1
(43) Pub. Date: Mar. 14, 2024

(54) HYBRID BEARING FAULT PROGNOSIS WITH FAULT DETECTION AND MULTIPLE MODEL FUSION

(71) Applicant: UNIVERSITY OF SOUTH CAROLINA, COLUMBIA, SC (US)

(72) Inventors: GUANGXING NIU, WEST COLUMBIA, SC (US); BIN ZHANG, IRMO, SC (US)

(21) Appl. No.: 18/462,471

(22) Filed: Sep. 7, 2023

Related U.S. Application Data
(60) Provisional application No. 63/405,566, filed on Sep. 12, 2022.

(51) Int. Cl. G01M 13/045; G06N 3/045; G06N 3/08

(52) U.S. Cl. CPC G01M 13/045; G06N 3/045; G06N 3/08

(57) ABSTRACT

A system and method concerns accurate bearing fault diagnosis and prognosis (FDP), critical for optimal maintenance schedules, safety and reliability. Existing methods face challenges: the bearing condition is healthy in most of the service time, so it is critical to detect the occurrence of faults and the start point for prognosis in real applications. Due to differences in manufacturing quality, assembly quality, and different operating conditions, it is difficult to describe the fault dynamic using one single fault model. A hybrid Bayesian estimation-based bearing FDP framework with fault detection and automatic fault model selection is disclosed. A convolutional neural network is used to detect fault and select the appropriate fault dynamic model. To improve performance with different bearings under different operating conditions, continuous wavelet coefficient matrices power spectrum of vibration are fused with operating conditions to build information maps for fault detection and model selection. After a fault is detected, a Bayesian estimation based FDP method is triggered to estimate the fault state and predict the remaining useful life. In the prognostic process, Dempster-Shafer theory is employed to fuse prediction results from different models if necessary.

### PRIORITY CLAIM

The present application claims the benefit of priority of U.S. Provisional Patent Application No. 63/405,566, titled Hybrid Bearing Fault Prognosis With Fault Detection And Multiple Model Fusion, filed Sep. 12, 2022, and which is fully incorporated herein by reference for all purposes.

### STATEMENT REGARDING SPONSORED RESEARCH OR DEVELOPMENT

This invention was made with government support under Grant No. N00174-17-1-0006, awarded by NEEC. The government has certain rights in the invention.

### BACKGROUND OF THE PRESENTLY DISCLOSED SUBJECT MATTER

The disclosure deals with a system and method for hybrid bearing fault prognosis with fault detection and multiple model fusion. In other respects, the present disclosure may be understood as relating to hybrid rotating machinery fault diagnosis and prognosis.

Bearings are critical components in rotating machinery. The degradation, fault, or failure of bearings can cause system breakdown and unexpected catastrophes. To improve reliability and reduce maintenance costs, predictive maintenance strategies are developed in which bearing fault diagnosis and prognosis (FDP) plays an important role. It involves estimating the current condition and predicting the remaining useful life (RUL) of bearings. The research of bearing FDP mainly focuses on model-based and data-driven approaches and has achieved remarkable achievements. Model-based methods use mathematical or physical models (which are often built or derived based on fault mechanisms) to describe fault dynamics. In practice, it is difficult to build an accurate mathematical or physical model due to complexity of fault dynamics and mechanisms. Data-driven approaches rely on analyzing historical monitoring data to train a model for state estimation and RUL prediction. With the advancement of sensing techniques, data-driven approaches have been widely investigated and used in many applications. However, the efficiency of these methods rely heavily on the quantity and quality of data. Previous research shows that model-based and data-driven approaches have unique advantages and disadvantages.

In the whole service life, bearings usually experience different stages, which can be defined as a run-in stage, a steady-state stage, and a faulty stage^{[1]}. Most of the service time is in the steady-state stage, which is a long steady process before a fault occurs. In the run-in and steady-state stages, bearings are in healthy condition. The time duration of healthy stages of different bearings varies a lot due to manufacturing, operating condition, assembly quality, etc. In the steady-state stage, only online anomaly detection is needed, while bearing FDP is not necessary as it leads to large computation and unreliable prognostic results. However, at the end stage of their service life, bearings usually experience a fast and severe degradation phase. Therefore, it is necessary and significant to identify the bearing operating stages and accurately estimate the start-to-prognosis (STP) time instant for RUL prediction.

In practice, bearings often show different fault modes and present different degradation trends in the faulty stage. This makes it difficult to describe different degradation dynamics using one fault dynamic model even with parameter adaptation. As a result, it is important to select the most appropriate fault dynamic model to conduct FDP for different fault modes. However, the model selection methods in most existing works are designed using threshold setting or machine learning methods^{[2]}. The measurements (features or fault indicators extracted from raw data) often show random fluctuations due to system noise or other interference, which may yield false detection and then affect the accuracy of model selection. Moreover, fault dynamics modeling should consider other factors, including operating conditions (directly affecting bearings degradation and service life) and domain knowledge (benefiting diagnosis and prognosis). Unfortunately, they are neglected in most existing works and are only considered in limited existing works^{[3]}.

Thus, accurate bearing FDP is critical for optimal maintenance schedules, safety, and reliability. The existing methods face some problems and challenges: First, since the bearing condition is healthy in most of the service time, it is critical to detect the occurrence of faults and the start point for prognosis in real applications. And second, due to the difference in manufacturing quality, assembly quality, and different operating conditions, it is difficult to describe the fault dynamic using one single fault model.

### SUMMARY OF THE PRESENTLY DISCLOSED SUBJECT MATTER

With such motivations, this disclosure presents a hybrid Bayesian estimation-based bearing FDP framework with fault detection and automatic fault model selection. In the proposed approach, convolutional neural network is used to detect fault and to select the appropriate fault dynamic model. To improve the performance, continuous wavelet coefficient matrices power spectrum of vibration are fused with operating conditions to build information maps for fault detection and model selection. After a fault is detected, Bayesian estimation-based FDP method is triggered to estimate the fault state and predict the remaining useful life. In the prognostic process, the Dempster-Shafer theory is employed to fuse prediction results from different models, if necessary. The proposed approach is verified with different bearings under different operating conditions. Experimental results and comparison studies demonstrate that the proposed approach can achieve better performance in terms of accuracy and efficiency.

In other respects, this disclosure proposes a hybrid Bayesian estimation-based bearing FDP approach. The proposed method consists of two major offline components: Health Indicator (HI) and model training; and four major online components: convolutional neural network (CNN)-based STP detection; CNN-based model selection; particle filter (PF)-based prognosis; Dempster-Shafer theory (DST)-based prediction fusion. This work combines the powerful feature learning and pattern recognition ability of deep learning, and the ability of the Bayesian estimation to state the estimation and the uncertainty management. In the implementation, HI, fault dynamic model, and CNN models are extracted or trained offline with experimental data. HI is constructed from the raw data and a fault dynamic model is established from the extracted HI for FDP. Two CNN models are trained using bearing information maps, which include fused information of raw vibration data and domain knowledge. In this work, CNN is adopted for STP detection and model selection due to its powerful feature learning and pattern recognition ability^{[4]-[8]}. In the online prognosis process, the offline fault and STP is detected using the fault detection CNN. After the detection of STP, the prognosis process is executed with PF, in which the fault dynamic models are selected using the model selection CNN. A DST-based fusion is proposed to further improve the prognostic performance by fusing the results from different models.

The main contributions of some aspects of the proposed method may be summarized as follows: 1) Propose a hybrid Bayesian estimation-based bearing FDP framework with CNN-based STP detection and model selection to improve FDP efficiency, accuracy, and applicability; 2) build an information map that integrates continuous wavelet coefficient matrices (CWCM) power spectrum of vibration and operating condition as the input of CNN for STP detection and fault model selection to improve the accuracy and training convergence speed of CNN; and 3) design a CNN-based automatic model selection and DST-based fusion in PF-based bearing FDP to improve accuracy and robustness of prognosis. Results and comparison studies for bearings under different operating conditions demonstrate the effectiveness of the proposed method. The rest of the disclosure is organized as follows: Section I presents an overview of the proposed approach, and Section II verifies the proposed method on bearing run-to-failure cases.

Experimental results are analyzed and compared with state-to-art methods to show the effectiveness of the proposed method. The conclusion and future work are presented in Section III.

While the present subject matter relates to areas of mechanical and/or electromechanical subject matter, additional specific subject matter in some instances may relate to rotating machinery systems and bearings, convolutional neural network, continuous wavelet transform, STP estimation, fault model selection, particle filter, and Dempster-Shafer theory subject matter.

It is to be understood that the presently disclosed subject matter equally relates to systems and devices, and to associated and/or corresponding methodologies. One exemplary such method relates to methodology for bearing fault diagnosis and prognosis (FDP). Such exemplary methodology preferably comprises monitoring a target bearing to obtain vibration data from the target bearing; processing the vibration data into processed data; inputting the processed data into a machine-learned start-to-prognosis (STP) fault detection convolutional neural network (CNN) trained to diagnose the occurrence of a fault in the target bearing based on the processed data; when a fault is diagnosed by the STP fault detection CNN, triggering operation of a machine-learned fault model-selection convolutional neural network (CNN) trained to identify the probabilities of accuracy when using candidate fault dynamic models based on data associated with the target bearing; and fusing results from one or more fault models with particle filter (PF) based analysis to produce prognosis of remaining useful life (RUL) for the target bearing.

Another exemplary such method relates to a method for hybrid bearing fault prognosis with fault detection and multiple model fusion, for bearing fault diagnosis and prognosis (FDP) which estimates current fault condition and predicts remaining useful life (RUL) of bearings. Such method preferably comprises creating power spectrums of continuous wavelet coefficient matrices of vibration data from monitored bearings which are fused with operating conditions of monitored bearings to build information maps for fault detection and fault model selection; inputting the information maps into a machine-learned start-to-prognosis (STP) fault detection convolutional neural network (CNN) trained to diagnose the occurrence of a fault in a corresponding bearing based on the information maps; when a fault is diagnosed by the STP fault detection CNN, triggering operation of a machine-learned fault model-selection convolutional neural network (CNN) trained to identify at least one appropriate fault dynamic model based on data associated with the corresponding bearing; and after a fault is diagnosed, triggering a Bayesian estimation based FDP analysis to estimate the fault state and predict the remaining useful life (RUL) of the corresponding bearing.

Other example aspects of the present disclosure are directed to systems, apparatus, tangible, non-transitory computer-readable media, user interfaces, memory devices, and electronic devices. To implement methodology and technology herewith, one or more processors may be provided, programmed to perform the steps and functions as called for by the presently disclosed subject matter, as will be understood by those of ordinary skill in the art.

Another exemplary embodiment of presently disclosed subject matter relates to a computing system for hybrid rotating machinery fault diagnosis and prognosis is described. Preferably, such exemplary computing system comprises a machine-learned start-to-prognosis (STP) fault detection convolutional neural network (CNN) trained to identify the occurrence of a fault in a piece of monitored rotating machinery based on data associated with the piece of monitored rotating machinery; a machine-learned fault model-selection convolutional neural network (CNN) trained to identify the probabilities of accuracy when using candidate fault dynamic models based on data associated with the piece of monitored rotating machinery; one or more processors; and one or more non-transitory computer-readable media that store instructions that, when executed by the one or more processors, cause the one or more processors to perform operations, the operations comprising when a fault is detected by the STP fault detection CNN, triggering operation of the fault model-selection CNN, and if necessary, fusing fault model selection and determining prognostic results with particle filter (PF) based prognosis.

Additional objects and advantages of the presently disclosed subject matter are set forth in, or will be apparent to, those of ordinary skill in the art from the detailed description herein. Also, it should be further appreciated that modifications and variations to the specifically illustrated, referred and discussed features, elements, and steps hereof may be practiced in various embodiments, uses, and practices of the presently disclosed subject matter without departing from the spirit and scope of the subject matter. Variations may include, but are not limited to, substitution of equivalent means, features, or steps for those illustrated, referenced, or discussed, and the functional, operational, or positional reversal of various parts, features, steps, or the like.

Still further, it is to be understood that different embodiments, as well as different presently preferred embodiments, of the presently disclosed subject matter may include various combinations or configurations of presently disclosed features, steps, or elements, or their equivalents (including combinations of features, parts, or steps or configurations thereof not expressly shown in the figures or stated in the detailed description of such figures). Additional embodiments of the presently disclosed subject matter, not necessarily expressed in the summarized section, may include and incorporate various combinations of aspects of features, components, or steps referenced in the summarized objects above, and/or other features, components, or steps as otherwise discussed in this application. Those of ordinary skill in the art will better appreciate the features and aspects of such embodiments, and others, upon review of the remainder of the specification, and will appreciate that the presently disclosed subject matter applies equally to corresponding methodologies as associated with practice of any of the present exemplary devices, and vice versa.

These and other features, aspects and advantages of various embodiments will become better understood with reference to the following description and appended claims. The accompanying figures, which are incorporated in and constitute a part of this specification, illustrate embodiments of the present disclosure and, together with the description, serve to explain the related principles.

### BRIEF DESCRIPTION OF THE FIGURES

A full and enabling disclosure of the present subject matter, including the best mode thereof to one of ordinary skill in the art, is set forth more particularly in the remainder of the specification, including reference to the accompanying figures in which:

FIG. 1 is a schematic of an exemplary embodiment of presently disclosed hybrid particle filter (PF)-based fault diagnosis and prognosis (FDP) subject matter;

FIG. 2 illustrates wavelet power spectrums of a bearing in run-to-failure experiments;

FIG. 3 is a schematic of built operating condition image being fused with continuous wavelet coefficient matrices (CWCM) to build bearing information maps;

FIG. 4 is a graph representing bearing start-to-prognosis (STP) detection;

FIG. 5 is a graph of aspects and results of presently disclosed fault modeling with uncertainty, to capture the uncertainty of different bearing degradation cases, with the models built as probability models, in which the parameters are subject to different distributions;

FIG. 6 is a graph representing aspects of the presently disclosed Dempster-Shafer Theory (DST) based prognostic remaining useful life prediction (RUL) fusion process;

FIG. 7 is a graph representing extracted Health Indicators (His) for different bearings;

FIG. 8 is a graph representing the presently disclosed bearing fault detection result of exemplary Bearing 1_2;

FIG. 9 is a graph representing the presently disclosed bearing fault detection result of exemplary Bearing 1_3;

FIG. 10 is a graph representing the presently disclosed bearing fault detection results for an exemplary bearing showing prognostic results at the 13th cycle after the STP detection;

FIG. 11 is a graph representing the presently disclosed RUL prediction result of exemplary Bearing 1_3; and

FIG. 12 is a graph showing presently disclosed fusion of prognosis processes using multiple models of Bearing 1_3 at the 28th time instant, which triggers the DST-based fusion process for prognosis.

Repeat use of reference characters in the present specification and drawings is intended to represent the same or analogous features or elements of the presently disclosed subject matter.

### DETAILED DESCRIPTION OF THE PRESENTLY DISCLOSED SUBJECT MATTER

Reference will now be made in detail to various embodiments of the disclosed subject matter, one or more examples of which are set forth below. It is to be understood by one of ordinary skill in the art that the present disclosure is a description of exemplary embodiments only, and is not intended as limiting the broader aspects of the disclosed subject matter. Each embodiment is provided by way of explanation of the subject matter, not limitation thereof. In fact, it will be apparent to those skilled in the art that various modifications and variations may be made in the present disclosure without departing from the scope or spirit of the subject matter. For instance, features illustrated or described as part of one embodiment may be used in another embodiment to yield a still further embodiment. Thus, it is intended that the presently disclosed subject matter covers such modifications and variations as come within the scope of the appended claims and their equivalents.

In general, the present disclosure is directed to systems and methods concerning accurate bearing fault diagnosis and prognosis (FDP), critical for optimal maintenance schedules, safety and reliability. A hybrid Bayesian estimation-based bearing FDP framework with fault detection and automatic fault model selection is disclosed. A convolutional neural network is used to detect fault and select the appropriate fault dynamic model. To improve performance with different bearings under different operating conditions, continuous wavelet coefficient matrices power spectrum of vibration are fused with operating conditions to build information maps for fault detection and model selection. After a fault is detected, a Bayesian estimation-based FDP method is triggered to estimate the fault state and predict the remaining useful life. In the prognostic process, Dempster-Shafer theory is employed to fuse prediction results from different models if necessary.

### I. The Proposed Approach

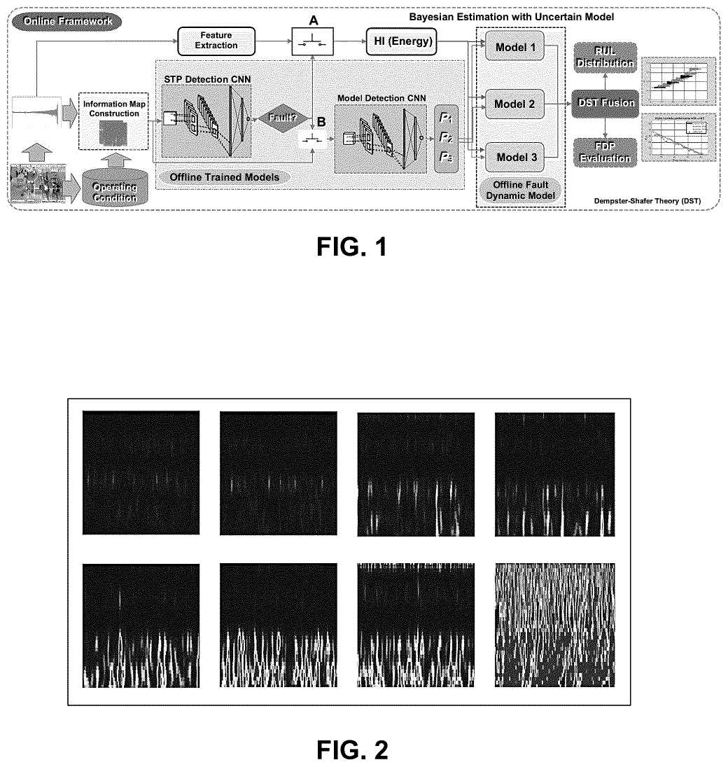

FIG. 1 shows the framework of the proposed method, which includes feature extraction, offline modeling, information map construction, online fault & STP detection, PF-based FDP, and DST-based fusion. The implementation is as of
1) Take a segment of vibration signals and transform it into CWCM energy spectrum images, which are combined with operating conditions to build information maps.
2) Offline CNN training: Construct and train two CNNs using the information maps. One is for fault and STP detection. The other one is for fault model selection.
3) Offline fault dynamic modeling: Extract HI from raw vibration data, group the HI data, and build different fault dynamic models based on the HI.
4) Design PF based FDP framework with the selected fault dynamic model, which includes state estimation, RUL prediction, and DST based prognostic fusion if necessary.
5) In online implementation, information maps are constructed from real-time data for STP detection. When a fault is detected, A and B switch on to trigger fault model selection and PF-based prognosis. If necessary, prognostic results from different models are fused by DST.

### A. CWCM-CNN for STP Estimation and Model Selection

1) Continuous wavelet transform (CWT): CWT is a time-frequency domain signal processing approach that provides a time-scale view of signals [3]. The transformed signal is obtained by applying a family of wavelet functions, defined by translation r and scale a, on raw signals. The translation defines the location of the wavelet, while the scale, defined as a=1/f, relates to the stretching or compressing scale of the wavelet. The transform is defined as:

$$CWT ( a , τ ) = \frac{1}{\sqrt{a}} {\int }_{- ∞}^{+ ∞} f ( t ) * Ψ ( \frac{t - τ}{a} ) dt \qquad ( 1 )$$

where ψ is the mother wavelet the Morlet wavelet is used here.

This decomposes raw signal fit) into CWCMs. FIG. 2 shows the wavelet power spectrum of a bearing in the run-to-failure experiments. The images show that the bearing vibration has apparent energy distribution in the degradation process.

2) Fusion of CWCM and operating condition: Operating conditions, including rotating speed, loading profile, temperature, etc., have great effects on bearing degradation rate and fault state. For example, the service life may reduce a lot for a system operating in a high-stress condition, such as high load and high speed. Vibration signals at different operating conditions show different features in terms of energy, noise, frequency, amplitude, among others. Therefore, it is important information and should be integrated into the FDP process.

In this work, two operating conditions—loading profile and rotating speed—are considered. To insure the uniformity of CWCM images with the operating information, an empty image with the same size as the CWCM image is built. The background color of the empty image is defined as the level of the loading profile. The rotating speed information is integrated into the empty image using color bands in different locations. According to CWT, the vertical axis of CWCM is the frequency that corresponds to scale a as:

$${F}_{a} = \frac{{F}_{c} \cdot f \text{?}}{a} \qquad ( 2 )$$

$$\text{?} \text{indicates text missing or illegible when filed}$$

where F_{c} is the center frequency of the wavelet function, Fₐ is the related frequency of scale a.

Based on the relationship, the location of the color band can be estimated as:

$${i}_{fr} = \frac{{F}_{c} \cdot {f}_{s}}{{f}_{r}} \qquad ( 3 )$$

where i_{f}_{ᵣ} is the location of color band, f_{c} is the signal sampling frequency, fᵣ is bearing rotating frequency, which can be obtained as fᵣ=rₚ/60, rₚ is the rotating speed with the unit of rpm.

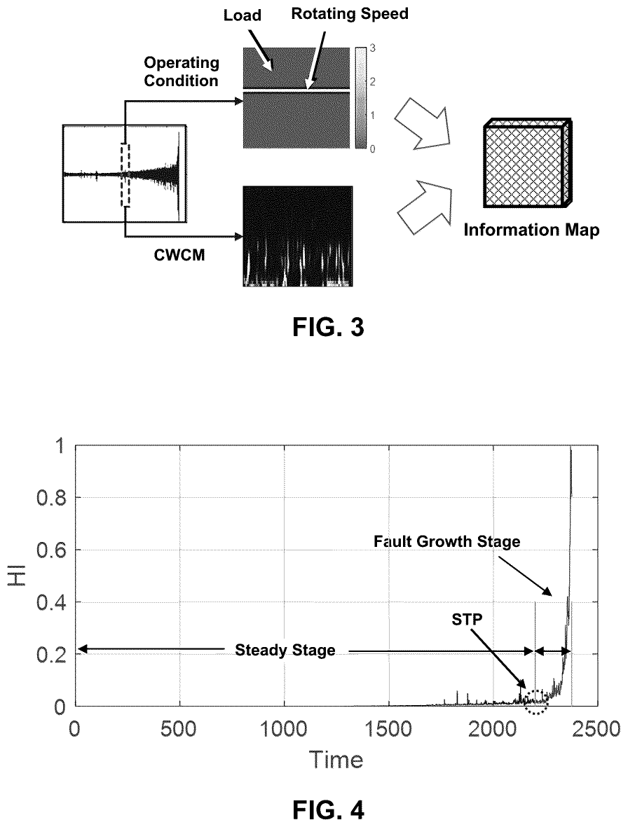

After estimating the location, a color band can be added to locations that correspond to different rotating speeds. The built operating condition images are then fused with CWCM to build bearing information maps as FIG. 3. For each snapshot of raw data, an information map is built for the following FDP process.

3) CNN-based fault detection and model selection: Accurate detection of the occurrence of a bearing fault and a good fault dynamic model are critical for FDP. CNN is a classical deep learning technology that has achieved promising results in bearing FDP as it is able to process original data with minimal amounts of pre-processing. A classic CNN is mainly composed of alternating convolutional layers, pooling layers, and fully connected layers. In the convolutional layer, a set of filters are applied on the input images to extract feature maps. The pooling layer down-samples the feature maps to reduce the dimension of convolution features. The extracted features are finally integrated in fully connected layer as the input of classifier to calculate the probabilities of bearing health condition (healthy or faulty).

Two two-dimensional CNNs, i.e., STP detection CNN and model-selection CNN, are trained separately for fault detection (STP detection) and fault dynamic model selection. STP detection aims to detect the occurrence of a bearing fault and to estimate the STP for execution of prognosis. The input of STP detection is the fused bearing information maps of the energy spectrum of CWCM and the operating information. The output is bearing health condition labels that can indicate the fault state (health or fault). Note that the STP detection CNN only uses the information map at the current time instant for detection. When a fault is detected, model-selection CNN selects the most appropriate fault dynamic model for prognosis. Since the degradation model for prognosis describes the fault growth trends, it requires several consecutive historical information maps as the input vector of the model selection CNN. The output of the model-selection CNN is the probabilities of candidate fault dynamic models. The probabilities are then used for fusion and decision-making.

Bearing STP is the time instant when a bearing fault is detected. A detection threshold is defined to reduce false alarm and noise. The bearing is considered as faulty only when a fault is detected by successive m inputs. After STP is estimated, several consecutive historical information maps are then used as the input of fault selection model to select the appropriate fault models for prognosis.

The proposed STP detection CNN and model selection CNN include training and testing process. The training set is represented by Dₜᵣₐᵢₙ^{F}={Xₜ^{F}; Yₜ^{F},}, Dₜᵣₐᵢₙ^{M}={Xₜ₋ₖ^{M}, Xₜ₋ₖ₊₁^{M}, . . . , Xₜ^{M}; Yₜ^{M}}, where Xₜ^{F}, Xₜ^{M} are bearing information maps for STP detection and fault dynamic model selection, respectively, Yₜ^{F} is the label indicating the bearing health stage at time t, and Yₜ^{M} represents the labels of different models. Then, CNNs are trained on Dₜᵣₐᵢₙ to learn the potential patterns by analyzing bearing information maps to detect fault and select appropriate fault models. For each bearing dataset, the data are divided into healthy datasets and faulty datasets manually to train the CNN for fault detection. The model selection CNN is triggered only when a bearing fault is detected. Therefore, the model selection CNN is trained using the information maps that built from the datasets that are divided as faulty. The leave-one-out training procedure is used in this work. For example, if N bearing datasets are used in verification, at each training and testing process, N−1 datasets are used as training and the remaining one is used for testing and online FDP.

### B. Bearing FDP Using Particle Filtering

1) HI: HI construction is the first and critical step in bearing FDP as the performance of fault dynamic model, state estimation, and RUL prediction rely heavily on the quality of HI. A high-quality HI should accurately indicate the degradation of bearings. Based on the bearing analysis results in the time-domain, frequency domain, and time-frequency domain, energy is selected as HI since it presents clear degradation trends in the faulty stages. HI can be considered as fault severity of bearing, which is defined as the ratio of the power of CWCM to its maximum power, i.e., (HIₜ=E(t)/Em), where E(t) is the energy of power spectrum of bearing at time t, Eₘ is the maximum energy in the run-to-failure process.

2) Fault dynamic model: The fault growth dynamics can be generally described as:

xₖ=f(xₖ₋₁,wₖ) (4a)

zₖ=h(xₖ,vₖ) (4b)

where k is time stamp, x is the fault state, f(⋅) depicts the bearing state transition, h(⋅) is the measurement equation, z is the state measurement, wₖ and vₖ are process and measurement noises, respectively.

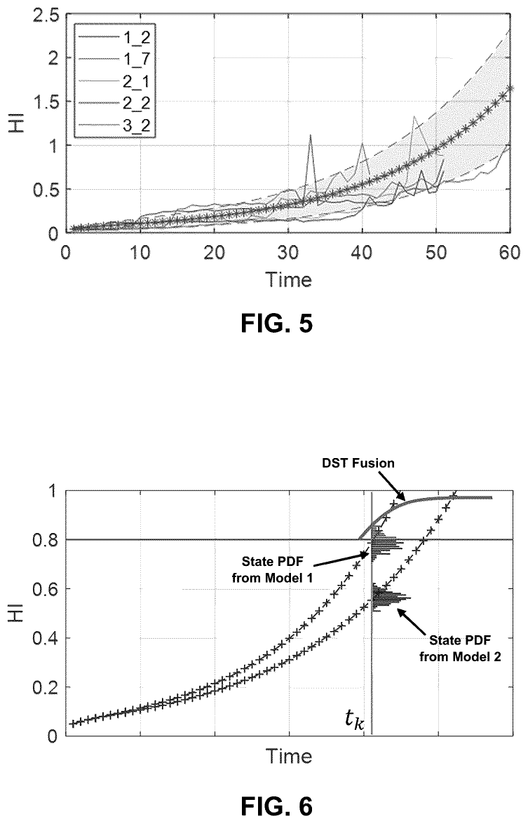

Since bearing state cannot be measured, HI is used as the state. For this setting, Eq. (4b) reduces to zₖ=xₖ+vₖ. To capture the uncertainty of different bearing degradation cases, the models are built as probability models, in which the parameters are subject to different distributions. FIG. 5 shows the results of model.

The diagnostic algorithm is executed from the estimated STP t_{STP} to estimate the current health state. Prognosis is the procedure of long-term (multistep) prediction and RUL calculation. The process involves two stages: 1) to calculate the fault state distribution at each future time instant by using the fault state model repeatedly. The prediction step is carried out with a fixed time internal from the current time tₖ to the failure time instant t_{f} when the fault state reaches the failure threshold F_{f}. The prediction steps are {tₖ, tₖ₊₁, . . . , tₖ₋₁, t_{f}} and the predicted fault state mean value of the distribution at these time instants can be denoted as {F(tₖ), F (tₖ₊₁), . . . , F(t_{f})}. Since no measurement is available in this long-term prediction, the uncertainty increases as the prediction horizon increases, which needs to be properly addressed. And, 2) to compare the fault state pdf at all time instants with the failure threshold by using the law of total probabilities to get the time to failure (TTF) or RUL distribution. Then, the RUL can be calculated by comparing the distributions of fault state at all prediction steps with the failure threshold. The prognosis is conducted at every time instant to get a RUL distribution.

3) Bearing FDP using PF: In this long-term prediction of prognosis, uncertainty is a key factor that should be addressed. Bayesian estimation techniques^{[9]} provide a general rigorous solution for uncertainty management. In this research, PF is employed for its advantages in nonlinear representation and uncertainty management.

Mathematically, the bearing fault states X can be described by a Markov process characterized by the initial distribution p(x₀) and the transition probability p(xₖ|xₖ₋₁) defined in Eq. (4a). Define x_{0:k}={x₀, . . . , xₖ} and y_{1:k}={y₁, . . . , yₖ} as the state and measurement. It is of interest to estimate the posterior distribution p(x_{0:k}|y_{1:k}). Based on the Bayesian estimation theory, the task involves two steps, i.e., prediction and filtering.

The prediction step is conducted to get the a priori state estimation at time k. Suppose the state probability distribution at time k−1 is known, the approximation of the a priori distribution of current state can be estimated as:

p(xₖ|y_{1:k-1})=∫p(xₖ|xₖ₋₁)p(xₖ₋₁|y_{1:k-1})dxₖ₋₁ (5)

where p(xₖ₋₁|y_{1:k-1}) is the state distribution at time k−1.

The filtering step is conducted with a new measurement to get a posteriori probability distribution p(xₖ|y_{1:k}) as:

$$p ( {x}_{k} \vert {y}_{1 : k} ) = \frac{p ( {y}_{k} \vert {x}_{k} ) p ( {x}_{k} \vert {y}_{1 : k - 1} )}{p ( {y}_{k} \vert {y}_{1 : k - 1} )} \qquad ( 6 )$$

where p(yₖ|xₖ) is the likelihood function at time k.

Since many bearing fault dynamics are nonlinear or non-Gaussian, PF method is used to approximate the optimal solution. Firstly, a set of N particles {xₖ₋₁ⁱ, wₖ₋₁ⁱ}, i=1, 2, . . . , N is assumed available at the time instant (k−1), where xₖ₋₁ⁱ define the locations of particles in the fault state space and wₖ₋₁ⁱ are the weights of particles with the sum of 1. The particles can be used to approximate the desired state distribution ψₖ₋₁(xₖ₋₁). The objective is to get a new set of particles {\hat{x}ₖⁱ, ŵₖⁱ} that can approximate the state distribution ψₖ(xₖ), where \hat{x}ₖⁱ are the location of new particles. Based on the theory of PF, the approximation can be estimated as:

$${ψ}_{k} ( {x}_{k} ) \approx {p}_{N} ( {x}_{k} \vert {y}_{1 : k} ) = {\sum }_{i = 1}^{N} {\hat{w}}_{k}^{i} δ ( {x}_{k} - {\hat{x}}_{k}^{i} ) \qquad ( 7 )$$

where δ is the Dirac-delta function, Σᵢ₌₁^{N}ŵₖⁱ=1.

The new particles can be obtained by extending the particles at k−1 using the importance density function qₜ as:

qₜ(\hat{x}_{0:k}ⁱ)=qₜ(\hat{x}_{0:k}|x_{0:t-1})·ψₖ₋₁(x_{0:k-1})dx_{0:k-1} (8)

The weights of new particles can be obtained as:

w(\hat{x}_{0:k}ⁱ)=w(xₖ₋₁ⁱ)p(yₖ|xₖⁱ)=w(xₖ₋₁ⁱ)hₖ(y_{1:k}|\hat{x}_{0:k}ⁱ) (9)

The bearing state can be estimated as:

$${x}_{k} = {\sum }_{i = 1}^{N} {\hat{w}}_{k}^{i} {\hat{x}}_{k}^{i} with {\hat{w}}_{k}^{i} = \frac{w ( {\hat{x}}_{0 : k}^{i} )}{{\sum }_{i = 1}^{N} w ( {\hat{x}}_{0 : k}^{i} )} \qquad ( 10 )$$

For each execution, the fault state xₖ₊₁ at the next time instant can be predicted as \tilde{x}ₖ₊₁⁽ⁱ⁾. The pdf p(\tilde{x}ₖ₊₁) can be approximated using the predicted particles.

Based on the state distribution at the current time instant, the state pdf p(\tilde{x}ₖ₊ⱼ), j=1, 2, f−k, of each future time instant can be extrapolated iteratively. In this process, the predicted state distribution is recursively taken as the input of fault model for predicting the state pdf at the next time instant. Based on this strategy, the state pdf at each future time instant {p(\tilde{x}ₖ₊₁), p(\tilde{x}ₖ₊₂), . . . , p(\tilde{x}_{f})} be predicted. Finally, the TTF pdf can be obtained by comparing those state pdf with the failure threshold. The RUL pdf can be obtained by calculating the time interval between the current time instant and the predicted TTF as:

$$p ( RUL ) \approx \frac{1}{N} {\sum }_{n = 1}^{N} δ ( {TTL}^{( i )} - k ) \qquad ( 11 )$$

where p(RUL|τₜ_{_{k−m+1}}:tₖ) is the predicted RUL pdf based on the fault state Fₖ₋ₘ₊₁:Fₖ, δ is the Dirac-Delta function.

4) RUL prediction fusion: To achieve better prognosis performance, RUL prediction fusion is conducted using DST when necessary. Since three models are defined for fault dynamic description, the output of model-selection CNN can be described as:

[P₁,P₂,P₃]=softmax(x) (12)

where P₁≥P₂≥P₃ are the ranked probabilities of model selection, x is the vector of the extracted features in the fully connected layer of model-selection CNN.

A high probability P₁ means that the model is selected with a strong confidence. The FDP is then conducted with the single selected fault model. On the contrary, if the selection probability is small, the fault model is selected with a weak confidence. In this case, the two models with higher probabilities P₁ and P₂ are used separately in PF to execute FDP parallelly. The final RUL is estimated by fusing predictions from two models using DST. The model selection threshold is set as 0.7 in this work.

DST is an extension of Bayesian methodology^{[11]}, which utilizes belief uncertainty intervals based on evidence of multiple observations to represent the belief of assumptions (boa)^{[11], [12]}, It is an effective decision fusion algorithm that exploits the probabilities of multiple pieces of uncertain evidence enclosed within the prediction process. It can provide the confidence of the occurrence of a specific event. The DST fusion of prognosis results from multiple models can be more sufficient and accurate to support decision-making.

Suppose two models are selected for prognosis. In this case, DST-based fusion is executed to fuse the results from two models as follows. In DST-based fusion, the frame of discernment is composed of bearing condition probabilities (Faulty (FT), Failure (FL)) and two source uncertainties (model selection uncertainty (MSU), and prediction uncertainty (PU)) as Θ={FT, FL, MSU, PU}. The faulty probability is defined as the probability that the state is detected as faulty but not yet reached the failure threshold (state pdf from Model 2) in FIG. 6. The failure probability is defined as the probability that the state has reached failure threshold, shown as pdf in FIG. 6. The basic probability assignment (BPA) for faulty, failure, model selection uncertainty, and prediction uncertainty are represented by m(FT), m(FL), m(MSU), m(PU), respectively. For example, m(failure) represents bearing failure probability, i.e., m(FL) evidence supports if there is a failure of bearing.

In the FDP process, uncertainties from two sources are considered: model selection uncertainty and prediction algorithm uncertainty. Model selection uncertainty is evidenced by the probability of model selection, which is quantified as a function of model selection probabilities as:

Uₛ=λ·(P₂/P₁) (13)

where P₁ and P₂ are the two model selection probabilities, λ is a parameter adjusting the effect of model selection in FDP process, which can be determined by trial-and-error.

Prediction uncertainty is evidenced by the state probability distribution function (pdf) at each time instant. It is defined using the spread function as:

Uₚ=S/Sₘₐₓ (14)

where S represents the spread function, which is represented as 2σ², and σ² is the variance of the state pdf, and Sₘₐₓ is the spread limit.

The BPA for the failure is assigned for prognosis as:

m(FL)ₖ=p(f|xₖ>ξ)·(1−MSU(k)−PU(k)) (15)

where ξ is the bearing failure threshold, k is the current time instant, p(⋅) is the probability function that describes the failure probability of the state when the prediction reaches the predefined failure threshold.

Based on the quantification rule, the values of different masses are described in Table I.

TABLE I
THE MASS COMBINATION OF PREDICTION USING DST

| | | Model 2 | | | |
|---|---|---|---|---|---|
| | | Faulty | Failure | Uncertaintyₘ | Uncertaintyₚ |
| Model 1 | | m₂(μ₁) | m₂(μ₂) | m₂(μ₃) | m₂(μ₄) |
| Faulty | m₁(μ₁) | m₁(μ₁) · m₂(μ₁) | m₁(μ₁) · m₂(μ₂) | m₁(μ₁) · m₂(μ₃) | m₁(μ₁) · m₂(μ₄) |
| Failure | m₁(μ₂) | m₁(μ₂) · m₂(μ₁) | m₁(μ₂) · m₂(μ₄) | m₁(μ₂) · m₂(μ₃) | m₁(μ₂) · m₂(μ₄) |
| Uncertaintyₘ | m₁(μ₃) | m₁(μ₃) · m₂(μ₁) | m₁(μ₃) · m₂(μ₂) | m₁(μ₃) · m₂(μ₃) | m₁(μ₃) · m₂(μ₄) |
| Uncertaintyₚ | m₁(μ₄) | m₁(μ₄) · m₂(μ₁) | m₁(μ₄) · m₂(μ₂) | m₁(μ₄) · m₂(μ₃) | m₁(μ₄) · m₂(μ₄) |

FIG. 6 is the DST-based prognostic fusion process. At each prognostic cycle, the mass function of each part can be obtained as Table I. The final prognostic results are the BPA combinations of failure m(FL) and uncertainty m(MUS, PU), the combination is the fused failure probability. The angled box in Table I represents the m(Fail) where the prognostic from two models agrees with each other. m(Fail) is the fusion mass function from two independent models. The bottom right box in Table I is the combined uncertainty m(U). They are given as:

m(Fail)=m₁(FL)·m₂(FL)+m₁(FL)·m₂(MSU)+m₁(FL)·m₂(PU)+m₁(MSU)·m₂(FL)+m₁(PU)·m₂(FL)

m(U)=m₁(MSU)·m₂(MSU)+m₁(MSU)·m₂(PU)+m₁(PU)·m₂(MSU)+m₁(PU)·m₂(PU)

After all BPA functions are estimated, the fused failure probability and uncertainty can be estimated as:

$${P}_{Fail} ( k ) = \frac{m ( Fail )}{1 - ( {m}_{1} ( FT ) \cdot {m}_{2} ( FL ) + {m}_{2} ( FT ) \cdot {m}_{1} ( FL ) )}$$

$${P}_{U} ( k ) = \frac{m ( U )}{1 - ( {m}_{1} ( FT ) \cdot {m}_{2} ( FL ) + {m}_{2} ( FT ) \cdot {m}_{1} ( FL ) )}$$

### II. Experiments and Analysis

In this Section, a series of bearing experimental results is presented to verify the proposed method. The experiments are implemented in MATLAB® R2018a environment running on a computer with Intel® Core™ i7-6700 CPU @ 3.40 GHz (8 CPUs) processor, 3.4 GHz 16G RAM.

### A. Data Description

The dataset is from IEEE 2012 Prognostics and Health Management Data Challenge^{[13]}. The testbed is composed of three main components: 1) rotating system, 2) loading part, and 3) measurement part. The bearings are operated in different loads and speeds. Two accelerometers, which are installed radially on the external race, are used to collect the bearing vibration data. The vibration are collected with a sampling rate of 25.6 kHz. Table II presents an overview of bearing datasets.

TABLE II
BEARING DATA DESCRIPTION

| Condition | Speed (rpm) | Load (N) | Dataset |
|---|---|---|---|
| Condition 1 | 1800 | 4000 | B1_1, B1_2, B1_3 |
| | | | B1_4, B1_5, B1_6 |
| Condition 2 | 1650 | 4200 | B2_1, B2_2, B2_3 |
| | | | B2_4, B2_5, B2_6 |
| Condition 3 | 1500 | 5000 | B3_1, B3_2, B1_3 |

### B. HI Construction and Fault Modeling

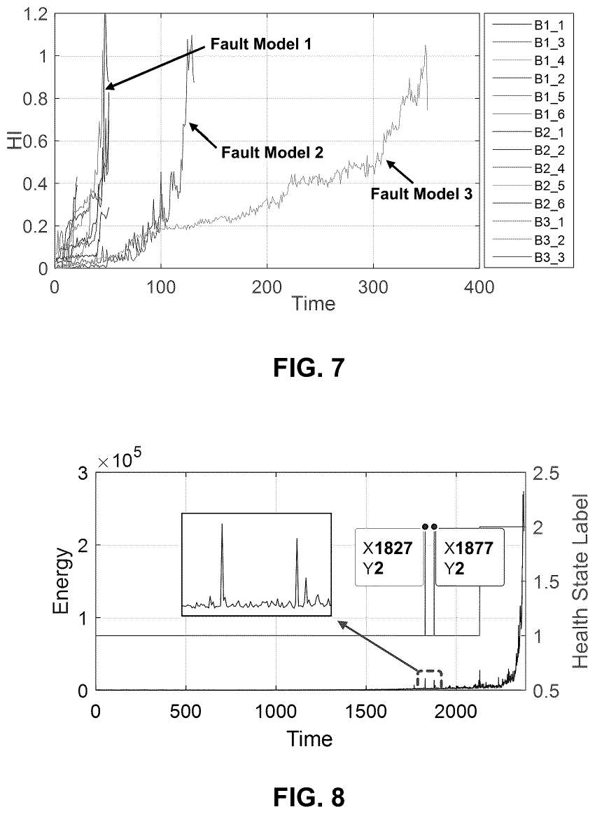

As mentioned earlier, HI is used as feature to describe fault dynamics. FIG. 7 shows the extracted His for different bearings. It is clear that these degradation processes of bearings can be described by three fault models. For this reason, three models are built for bearing FDP. To cover most bearing degradations for each fault mode, probabilistic models are used. The three probabilistic models are built as:

fₜ₊₁=fₜ+p₁·e^{p}^{₂}^{t}+w(t) (16a)

fₜ₊₁=fₜ+p₁·t³+p₂·t²+p₃·t+p₄+w(t) (16b)

where f is bearing HI, t is time index, p₁˜p₄ are the model parameters.

Fault models 1 and 2 are built as (16a), fault model 3 is built as (16b). The model parameters are identified for different models as shown in Table III. Note that the model parameters are subject to a Gaussian distribution to accommodate the uncertainty of fault dynamics.

TABLE III
MODEL PARAMETERS FOR DIFFERENT FAULT MODELS

| | |
|---|---|
| Parameter | Value |

| | | |
|---|---|---|
| Model 1 | p₁~N[9.11e⁻⁵, 0.0005] | p₂~N[0.0565, 0,005] |
| Model 2 | p₁~N[0.01139, 0.0005] | p₂~N[0.9199, 0.005] |
| Model 3 | p₁~N[9.86e⁻¹⁰, 0.0005] | p₃~N[4.1e⁻⁵, 0,005] |
| | p₂~N[−3.87e⁻⁷, 0.0005] | p₄~N[0.0006, 0.005] |

### C. STP Detection and Fault Model Selection

Two CNNs are trained for STP detection and model selection, respectively. STP detection CNN aims to detect bearing fault and estimate the STP for prognosis. The output of STP detection CNN is bearing health condition (healthy, faulty). Model selection CNN outputs the probabilities for three fault models. The training process is conducted based on the Adam optimizer^{[14]}. The initial learning rate and dropout rate are set as 0.01 and 0.3, respectively. The detailed structure of the trained model selection CNN is described in Table IV. The mini-batch size of the input is 125. The training process is terminated when the epochs reach the pre-defined training threshold of maximum epoch or identification accuracy. The overall average offline testing accuracy for STP detection and model selection are illustrated in Table V. Based on Table V, two CNN models can accurately detect bearing faults and select the most appropriate fault models for FDP.

TABLE IV
STRUCTURE OF THE PROPOSED
NETWORK IN MODEL SELECTION

| | | | Filter | |
|---|---|---|---|---|
| Layer | Layer Type | Filter Size | Count | Output |
| 1 | Input | — | — | 60 × 60 × 6 |
| 2 | Convolution | 5 × 5 × 1 | 100 | 60 × 60 × 100 |
| 3 | Maxpooling | — | — | 60 × 60 × 100 |
| 4 | Convolution | — | — | 60 × 60 × 100 |
| 5 | ReLU | 1 × 1 | 100 | 1 × 1 × 100 |
| 6 | Convolution | 5 × 5 × 3 | 30 | 5 × 5 × 3 |
| 7 | Max pooling | 2 × 2 × 3 | 30 | 5 × 5 × 3 |
| 8 | BN | — | 30 | 5 × 5 × 3 |
| 9 | Convolution | 5 × 5 × 3 | 30 | 5 × 5 × 3 |
| 10 | Max pooling | 2 × 2 × 3 | 30 | 5 × 5 × 3 |
| 11 | ReLU | — | — | 56 × 56 × 3 |
| 12 | Max Pooling | 4 × 4 × 3 | 30 | 53 × 53 × 3 |
| 13 | BN | — | — | 53 × 53 × 3 |
| 14 | ReLU | — | — | 53 × 53 × 3 |
| 15 | Dropout | — | — | 1 × 1 × 100 |
| 16 | Fully connected | 1 × 1 × 100 | 3 | 1 × 1 × 3 |
| 17 | Softmax | — | — | 1 |

TABLE V
ACCURACY OF STAGE IDENTIFICATION
AND MODEL SELECTION

| Task | Stage Identification | Fault Model Selection |
|---|---|---|
| Accuracy(%) | 98.27 | 96.04 |

FIG. 8 is the fault detection result of Bearing 1_3. Although the bearing is detected as faulty at 1827 s and 1877 s, they are not effective at detection since the state is identified as faulty only after three consecutive states are detected as failure. The fault is finally detected at 2143 s. It is clear that the fault detection results are almost consistent with the actual bearing condition. After a fault is detected, three consecutive historical information maps are combined as the input of model selection CNN to select fault prognostic model. The probabilities of the three models are [0.98, 0.01, 0.01]. Since P₁>0:7, Model 1 in Table III is selected to be implemented with PF to conduct prognosis for Bearing 1_3.

D. Fault Diagnosis and Prognosis with Single Fault Model

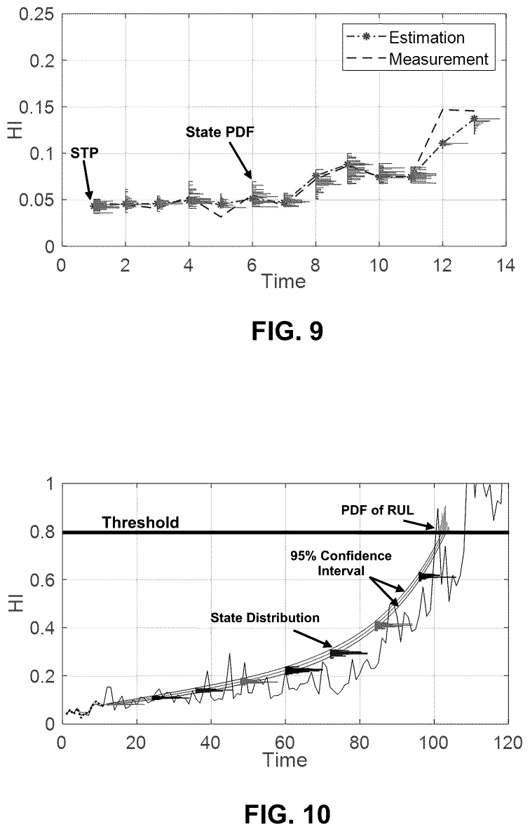

In the implementation, the selected single model is integrated in the PF-based FDP algorithm. In the diagnosis stage, the particle filter is configured with 100 particles. The failure threshold of HI is set as 0.8. FIG. 9 shows the diagnostic results for Bearing 1_3 at the 13th cycle after the detection of STP. The figure shows the comparison of the mean of bearing state pdf (dot, dash estimation) and the measurements (HI values) (dot, line measurement). The pdf of each estimation are also given to show estimation uncertainty.

After the bearing state distribution is obtained from diagnosis, it is used as the initial condition for prognosis to estimate the TTF. Since there is no measurement in prognosis, it is conducted based only on fault dynamic models. The prognosis is also configured with 100 particles. FIG. 10 shows the prognostic result at the 13th cycle after the STP detection. At each time instant, the mean value and the 95% confidence interval of the predicted fault state distributions are plotted. To make the figure clear, it only shows the state pdf on some selected time instants. Each prognosis process is terminated after all particles reach the failure threshold. The RUL pdf, which is given in the (upper right PDF of RUL), is obtained by collecting the time instants when the particles reach the failure threshold.

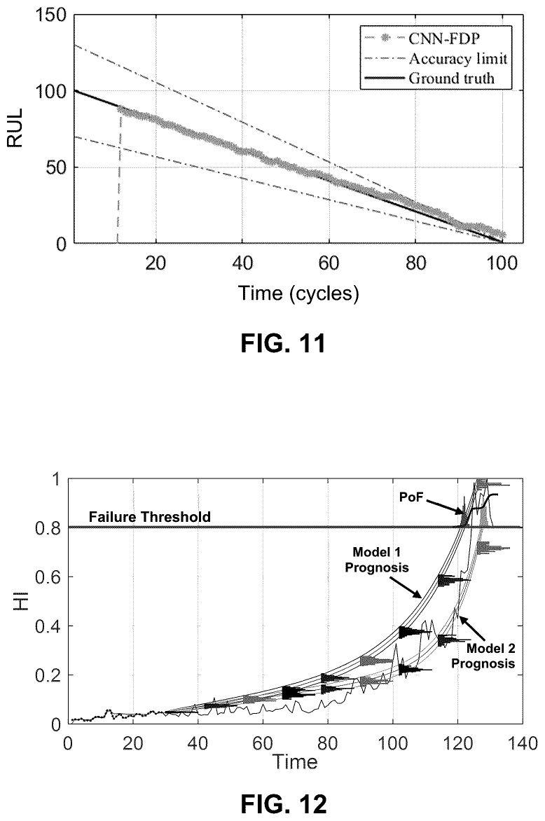

To demonstrate the RUL prediction accuracy in the whole bearing life, a−λ metrics^{[15]} with a=0.3 is used. This metrics shows whether the predicted RUL at any particular time instant falls into a defined precision range. FIG. 11 shows the RUL prediction results for Bearing 1_3. It is clear that 91% of the predicted RUL fall into the defined accuracy zones.

E. DST Fusion-Based FDP with Multiple Fault Models

As mentioned earlier, DST-based fusion process will be triggered when necessary. FIG. 12 shows a prognosis process using multiple models of Bearing 1_3 at the 28th time instant, which triggers the DST-based fusion process for prognosis. At current time instant, the model selection CNN yields probabilities of [0:63; 0:32; 0:05]. Since the probabilities of all models are less than 0.7. Model 1 and Model 2 are selected to run PF-based prognosis parallelly. For each prognosis cycle, two state pdfs are obtained from the two selected models. The mass function for the faulty state and failure state can be calculated based on the DST details described in Section I. For the failure prediction from Model 1 and Model 2, DST provides a fused failure probability based on the failure probabilities from two models. Bearing TTF is estimated using a detection probability 90%. Based on the figure, Model 1 has an early failure alarm, while Model 2 has a later failure alarm. The fused failure probability falls between the failure probabilities from Model 1 and Model 2. For example, at the 122nd time instant, the probability of failure (PoF) of Model 1 is 0.85, while the PoF of Model 2 is 0.08. The fused PoF is 0.53, which provides a more accurate failure alarm than single model. Based on the FDP execution mechanism described in Section I, DST-based FDP is triggered at the time instants when the model selection CNN outputs a weak selection. Table VI shows the average errors of the predicted RUL at several model fusion time instants from a single model and DST fusion. Clearly, DST-based fusion method can provide a RUL prediction with better performance.

TABLE VI
RUL PREDICTION ERROR COMPARISON

| Time Instant(s) | Model 1 | Model 2 | DST |
|---|---|---|---|
| 25 | 11 | 6 | 4 |
| 42 | 3 | 3 | 2 |
| 57 | 5 | 3 | 2 |
| 73 | 8 | 4 | 3 |
| Average Error | 6.75 | 4 | 2.75 |

### F. Results Comparison and Analysis

To further demonstrate the effectiveness of the proposed method, the results are analyzed and compared with some state-to-the-art methods in terms of accuracy and application economical efficiency using two different evaluation metrics.

1) Accuracy analysis: The results are first evaluated using Cumulative Relative Accuracy (CRA)^{[16]}. CRA is a widely used metric that comprehensively assesses the accuracy of a prognostics method by aggregating the relative prediction accuracies at all prediction times. It has the definition of:

$${CRA}_{λ} = \frac{1}{\vert {ℓ}_{λ \vert}} {\sum }_{i = 1}^{{ℓ}_{λ}} w ( r ( i ) ) {RA}_{λ} \qquad ( 17 )$$

where [symbol] _{λ} is the set of all time index of the predictions, w(r(i)) is a weight factor as a function of RUL at all prediction time indices.

The results are compared with genetic programming (GP) based RUL prediction method^{[17]}, Extend Kalman Filter (EKF) based method^{[18]}, and a multiobjective deep belief networks ensemble (MODBNE)^{[19]}. The performance results of the bearing cases that are used in all above works are compared in Table VII, in which the best CRA values are highlighted. The proposed method has higher prediction accuracy than the other three methods for most bearing cases.

TABLE VII
PERFORMANCE COMPARISON FOR
DIFFERENT METHODS USING CRA

| Bearing No. | GP [17] | EKF [18] | MODBNE [19] | Proposed |
|---|---|---|---|---|
| Bearing 1_1 | 0.6107 | 0.6209 | 0.4318 | 0.7313 |
| Bearing 1_2 | 0.7256 | 0.3500 | 0.6248 | 0.6653 |
| Bearing 1_3 | 0.4850 | 0.8010 | 0.5571 | 0.8000 |
| Bearing 1_4 | 0.2305 | 0.6839 | 0.4085 | 0.7636 |
| Bearing 1_5 | 0.4311 | 0.5042 | 0.6636 | 0.7140 |
| Bearing 2_1 | 0.3963 | 0.5150 | 0.5518 | 0.7557 |
| Bearing 2_2 | 0.2634 | 0.4314 | 0.2564 | 0.6946 |
| Bearing 2_4 | 0.4633 | 0.5004 | 0.5316 | 0.5840 |
| Bearing 3_2 | 0.1518 | 0.5362 | 0.5167 | 0.7797 |
| Bearing 3_3 | 0.1283 | 0.5167 | 0.6050 | 0.7002 |

provide accurate guidance and reference for system maintenance and mission planning. The potential economic loss is a significant factor in real applications. For example, if the predicted failure time falls later than the bearing actual failure time, it will cause unexpected breakdown and will result in economic loss or even catastrophic events.

Based on the consideration, a modified CRA (MCRA) is proposed for performance evaluation. In MCRA, the weights are assigned based on the prediction horizon and the absolute error (ahead or later) between the predicted RUL and the ground truth. It is given as:

$${MCRA}_{λ} = \frac{1}{\vert {ℓ}_{λ \vert}} {\sum }_{i = 1}^{{ℓ}_{λ}} {w}^{*} ( r ( i ) , D ) {RA}_{λ} \qquad ( 18 )$$

where D=sign(r_{*}(t_{λ})−r^{l}(t_{λ})) is the sign of the prediction error, and weight w* is defined as:

$${w}^{*} = g ( l , D ) = \{ \begin{matrix}{k}_{1} \cdot ( {t}_{f} - 1 ) + {k}_{2} , & D > 0 \\ {k}_{3} \cdot ( {t}_{f} - l ) + {k}_{4} , & D < 0\end{matrix} \qquad ( 19 )$$

where l is the length of the prediction horizon, g is the function to estimate the unique weight for each prediction, k=[0.005, 0.5, 0.008, 0.2] are the parameters for the two different linear weight functions, and t_{f} is the failure time.

MCRA takes more application-related factors into account and assigns distinguishing weight for each prediction.

TABLE VIII
PERFORMANCE COMPARISON FOR DIFFERENT
METHODS USING MCRA

| No. | B1_1 | B1_2 | B1_3 | B1_4 | B1_5 | B1_6 |
|---|---|---|---|---|---|---|
| GP [17] | 0.5045 | 0.6048 | 0.3560 | 0.1450 | 0.3210 | 0.4723 |
| Proposed | 0.6372 | 0.5973 | 0.7036 | 0.6713 | 0.6394 | 0.7530 |

Table VIII presents and compares the MRCA score. Note that the result of GP is based on our programming of the algorithms^{[17]}. The result shows that the proposed method has higher MCRA scores than GP method for most of the bearings.

### III. Conclusions

This disclosure presents a hybrid bearing FDP framework that integrates CNN based fault detection and model selection, Bayesian estimation-based FDP, and DST-based prognostic fusion. This approach combines the advantage of the strong learning and pattern identification ability of CNN, uncertainty representation ability of PF, and information fusion of different resources. Two CNN models are trained to detect the STP and select appropriate models for prognosis, which guarantees the computation efficiency and accuracy of FDP. DST fusion is applied to fuse the prognostic results when necessary. Experiments and comparisons show that the proposed method has high performance in accurate STP detection and RUL prediction. Our future work will focus on the implementation of the proposed method in Lebesgue sampling framework.

While certain embodiments of the disclosed subject matter have been described using specific terms, such description is for illustrative purposes only, and it is to be understood that changes and variations may be made without departing from the spirit or scope of the subject matter.

### REFERENCES

[1] Y. Lei, N. Li, L. Guo, N. Li, T. Yan, and J. Lin, “Machinery health prognostics: A systematic review from data acquisition to rul prediction,” Mechanical systems and signal processing, vol. 104, pp. 799-834, 2018.
[2] G. Xu, D. Hou, H. Qi, and L. Bo, “High-speed train wheel set bearing fault diagnosis and prognostics: A new prognostic model based on extendable useful life,” Mechanical Systems and Signal Processing, vol. 146, p. 107050, 2021.
[3] S. Guo, B. Zhang, T. Yang, D. Lyu, and W. Gao, “Multitask convolutional neural network with information fusion for bearing fault diagnosis and localization,” IEEE Transactions on Industrial Electronics, vol. 67, no. 9, pp. 8005-8015, 2019.
[4] K. Sun, Z. Huang, H. Mao, A. Qin, X. Li, W. Tang, and J. Xiong, “Multiscale cluster-graph convolution network with multi-channel residual network for intelligent fault diagnosis,” IEEE Transactions on Instrumentation and Measurement, 2021.
[5] J. Chen, R. Huang, K. Zhao, W. Wang, L. Liu, and W. Li, “Multiscale convolutional neural network with feature alignment for bearing fault diagnosis,” IEEE Transactions on Instrumentation and Measurement, vol. 70, pp. 1-10, 2021.
[6] Z. Zhu, G. Peng, Y. Chen, and H. Gao, “A convolutional neural network based on a capsule network with strong generalization for bearing fault diagnosis,” Neurocomputing, vol. 323, pp. 62-75, 2019.
[7] S. Gao, S. Shi, and Y. Zhang, “Rolling bearing compound fault diagnosis based on parameter optimization mckd and convolutional neural network,” IEEE Transactions on Instrumentation and Measurement, vol. 71, pp. 1-8, 2022.
[8] B. Yang, R. Liu, and E. Zio, “Remaining useful life prediction based on a double-convolutional neural network architecture,” IEEE Transactions on Industrial Electronics, vol. 66, no. 12, pp. 9521-9530, 2019.
[9] Y. Hu, F. Cui, X. Tu, and F. Li, “Bayesian estimation of instantaneous speed for rotating machinery fault diagnosis,” IEEE Transactions on Industrial Electronics, vol. 68, no. 9, pp. 8842-8852, 2020.
[10] L. Cui, W. Li, X. Wang, D. Zhao, and H. Wang, “Comprehensive remaining useful life prediction for rolling element bearings based on time-varying particle filtering,” IEEE Transactions on Instrumentation and Measurement, vol. 71, pp. 1-10, 2022.
[11] J. Weddington, G. Niu, R. Chen, W. Yan, and B. Zhang, “Lithium ion battery diagnostics and prognostics enhanced with dempster-shafer decision fusion,” Neurocomputing, vol. 458, pp. 440-453, 2021.
[12] T. G. Nachappa, S. T. Piralilou, K. Gholamnia, O. Ghorbanzadeh, O. Rahmati, and T. Blaschke, “Flood susceptibility mapping with machine learning, multi-criteria decision analysis and ensemble using dempster shafer theory,” Journal of Hydrology, p. 125275, 2020.
[13] E. Zio, “Prognostics and health management (phm): Where are we and where do we (need to) go in theory and practice,” Reliability Engineering & System Safety, vol. 218, p. 108119, 2022.
[14] S. Bock and M. Weill, “A proof of local convergence for the adam optimizer,” in 2019 International Joint Conference on Neural Networks (IJCNN), pp. 1-8. IEEE, 2019.
[15] S. Ochella and M. Shafiee, “Performance metrics for artificial intelligence (ai) algorithms adopted in prognostics and health management (phm) of mechanical systems,” in Journal of Physics: Conference Series, vol. 1828, no. 1, p. 012005. IOP Publishing, 2021.
[16] Z. Pan, Z. Meng, Z. Chen, W. Gao, and Y. Shi, “A two-stage method based on extreme learning machine for predicting the remaining useful life of rolling-element bearings,” Mechanical Systems and Signal Processing, vol. 144, p. 106899, 2020.
[17] L. Liao, “Discovering prognostic features using genetic programming in remaining useful life prediction,” IEEE Transactions on Industrial Electronics, vol. 61, no. 5, pp. 2464-2472, 2013.
[18] R. K. Singleton, E. G. Strangas, and S. Aviyente, “Extended Kalman filtering for remaining-useful-life estimation of bearings,” IEEE Transactions on Industrial Electronics, vol. 62, no. 3, pp. 1781-1790, 2014.
[19] C. Zhang, P. Lim, A. K. Qin, and K. C. Tan, “Multiobjective deep belief networks ensemble for remaining useful life estimation in prognostics,” IEEE transactions on neural networks and learning systems, vol. 28, no. 10, pp. 2306-2318, 2016.

What is claimed is:

1. A hybrid methodology for bearing fault diagnosis and prognosis (FDP), comprising:
monitoring a target bearing to obtain vibration data from the target bearing;
processing the vibration data into processed data;
inputting the processed data into a machine-learned start-to-prognosis (STP) fault detection convolutional neural network (CNN) trained to diagnose the occurrence of a fault in the target bearing based on the processed data;
when a fault is diagnosed by the STP fault detection CNN, triggering operation of a machine-learned fault model-selection convolutional neural network (CNN) trained to identify the probabilities of accuracy when using candidate fault dynamic models based on data associated with the target bearing; and
fusing results from one or more fault models with particle filter (PF) based analysis to produce prognosis of remaining useful life (RUL) for the target bearing.

2. A hybrid methodology according to claim 1, wherein fusing comprises fusing different models by Dempster-Shafer Theory (DST) analysis.

3. A hybrid methodology according to claim 1, wherein processing the vibration data into processed data comprises:
forming continuous wavelet coefficient matrices (CWCM) of data from the vibration data,
monitoring operation information from the piece of monitored rotating machinery, and
creating fused bearing information maps of the energy spectrum of the CWCM and operating information.

4. A hybrid methodology according to claim 3, wherein the information maps are constructed from real-time data for STP detection.

5. A hybrid methodology according to claim 1, further comprising extracting Health Indicator (HI) data from the vibration data.

6. A hybrid methodology according to claim 5, further comprising grouping the HI data, and building different fault dynamic models based on the HI data.

7. A hybrid methodology according to claim 3, wherein the continuous wavelet coefficient matrices (CWCM) comprise respective segments of vibration signals derived from vibration data which are transformed into CWCM energy spectrum images.

8. A computing system for hybrid rotating machinery fault diagnosis and prognosis, the computing system comprising:
a machine-learned start-to-prognosis (STP) fault detection convolutional neural network (CNN) trained to identify the occurrence of a fault in a piece of monitored rotating machinery based on data associated with the piece of monitored rotating machinery;
a machine-learned fault model-selection convolutional neural network (CNN) trained to identify the probabilities of accuracy when using candidate fault dynamic models based on data associated with the piece of monitored rotating machinery;
one or more processors; and
one or more non-transitory computer-readable media that store instructions that, when executed by the one or more processors, cause the one or more processors to perform operations, the operations comprising:
when a fault is detected by the STP fault detection CNN, triggering operation of the fault model-selection CNN, and if necessary fusing fault model selection and determining prognostic results with particle filter (PF) based prognosis.

9. A computing system according to claim 8, wherein the one or more processors are further programmed to fuse different models by Dempster-Shafer Theory (DST) analysis.

10. A computing system according to claim 9, wherein the one or more processors are further programmed to:
form continuous wavelet coefficient matrices (CWCM) of data from the piece of monitored rotating machinery,
monitor operation information from the piece of monitored rotating machinery, and
create the fused bearing information maps of the energy spectrum of CWCM and operating information.

11. A computing system according to claim 10, wherein the information maps are constructed from real-time data for STP detection.

12. A computing system according to claim 8, wherein the one or more processors are further programmed to extract Health Indicator (HI) data from raw vibration data associated with the piece of monitored rotating machinery.

13. A computing system according to claim 12, wherein the one or more processors are further programmed to group the HI data, and build different fault dynamic models based on the HI.

14. A computing system according to claim 9, wherein the one or more processors are further programmed to determine (PF)-particle filter based prognosis based on a selected fault dynamic model.

15. A computing system according to claim 14, wherein the one or more processors are further programmed to perform:
state estimation,
remaining useful life (RUL) prediction, and
Dempster-Shafer theory (DST) based prognostic fusion if necessary.

16. A computing system according to claim 10, wherein:
data from the piece of monitored rotating machinery comprises vibration signals,
and the one or more processors are further programmed to form continuous wavelet coefficient matrices (CWCM) which comprise respective segments of vibration signals which are transformed into CWCM energy spectrum images.

17. Method for hybrid bearing fault prognosis with fault detection and multiple model fusion, for bearing fault diagnosis and prognosis (FDP) which estimates current fault condition and predicts remaining useful life (RUL) of bearings, the method comprising:
creating power spectrums of continuous wavelet coefficient matrices of vibration data from monitored bearings which are fused with operating conditions of monitored bearings to build information maps for fault detection and fault model selection;
inputting the information maps into a machine-learned start-to-prognosis (STP) fault detection convolutional neural network (CNN) trained to diagnose the occurrence of a fault in a corresponding bearing based on the information maps;
when a fault is diagnosed by the STP fault detection CNN, triggering operation of a machine-learned fault model-selection convolutional neural network (CNN) trained to identify at least one appropriate fault dynamic model based on data associated with the corresponding bearing; and
after a fault is diagnosed, triggering a Bayesian estimation based FDP analysis to estimate the fault state and predict the remaining useful life (RUL) of the corresponding bearing.

18. A method according to claim 17, further comprising using Dempster-Shafer theory to fuse prediction results from different fault dynamic models if necessary.
